(19) United States
(12) Patent Application Publication
(10) Pub. No.: US 2026/0024309 A1
(43) Pub. Date: Jan. 22, 2026

(54) HIERARCHICAL TRANSFORMERS IN MACHINE LEARNING MODELS

(71) Applicant: QUALCOMM Incorporated, San Diego, CA (US)

(72) Inventors: Soenke BEHRENDS, Amsterdam (NL); Pim DE HAAN, Amsterdam (NL); Johann Hinrich BREHMER, Amsterdam (NL)

(21) Appl. No.: 18/965,654

(22) Filed: Dec. 2, 2024

Related U.S. Application Data
(60) Provisional application No. 63/673,993, filed on Jul. 22, 2024.

(51) Int. Cl. G06V 10/762; G06V 20/64

(52) U.S. Cl. CPC G06V 10/7625; G06V 20/64

(57) ABSTRACT

Certain aspects of the present disclosure provide techniques and apparatus for machine learning. In an example method, a set of tokens input to a hierarchical attention mechanism is accessed, where the set of tokens corresponds to a model input having a data hierarchy comprising a plurality of levels. A first attention output is generated based on processing a first partition of tokens, from the set of tokens, using a first masked attention operation, where the first partition of token corresponds to a first level of the plurality of levels. A second attention output is generated based on processing a second partition of tokens, from the set of tokens, corresponding to a first element at a second level of the plurality of levels using a second masked attention operation. An aggregated attention output is generated based on the first attention output and the second attention output.

### CROSS-REFERENCE TO RELATED APPLICATION(S)

The present application for patent claims the benefit of and priority to U.S. Provisional Application No. 63/673,993, filed Jul. 22, 2024, which is hereby expressly incorporated by reference herein in its entirety as if fully set forth below and for all applicable purposes.

### INTRODUCTION

Aspects of the present disclosure relate to machine learning.

A wide variety of machine learning model architectures have been trained to perform an assortment of diverse tasks, including computer vision tasks, language tasks, classification tasks, regression tasks, and the like. Recently, research has yielded substantial success in using large models (e.g., deep neural networks, large language models (LLMs), large vison models (LVMs), large multimodal models (LMMs), and the like) to process and generate output data. Often, machine learning models use attention mechanisms (e.g., transformer blocks) to allow portions of the data to attend to each other. This can significantly improve the accuracy and resilience of the models.

### BRIEF SUMMARY

Certain aspects of the present disclosure provide a processor-implemented method, comprising: accessing a set of tokens input to a hierarchical attention mechanism, wherein the set of tokens corresponds to a model input having a data hierarchy comprising a plurality of levels; generating a first attention output based on processing a first partition of tokens, from the set of tokens, using a first masked attention operation, wherein the first partition of tokens corresponds to a first level of the plurality of levels and comprises each token in the set of tokens; generating a second attention output based on processing a second partition of tokens, from the set of tokens, corresponding to a first element at a second level of the plurality of levels using a second masked attention operation; and generating an aggregated attention output based on the first attention output and the second attention output.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict example features of certain aspects of the present disclosure and are therefore not to be considered limiting of the scope of this disclosure.

FIG. 1 depicts an example workflow for hierarchical machine learning models, according to some aspects of the present disclosure.

FIG. 2 depicts example hierarchical data in machine learning models, according to some aspects of the present disclosure.

FIG. 3 depicts an example workflow for hierarchical attention in machine learning models, according to some aspects of the present disclosure.

FIG. 4 is a flow diagram depicting an example method for hierarchical attention in machine learning models, according to some aspects of the present disclosure.

FIG. 5 is a flow diagram depicting an example method for hierarchical machine learning, according to some aspects of the present disclosure.

FIG. 6 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatuses, methods, processing systems, and non-transitory computer-readable mediums for providing improved machine learning. Specifically, in some aspects of the present disclosure, techniques for hierarchical machine learning are provided.

In a wide variety of machine learning model architectures, attention (e.g., self-attention) is used to generate model output. For example, many models (such as LLMs, LVMs, and the like) use transformer-based self-attention operations. Many tasks to be solved using machine learning involve model input having a data hierarchy (e.g., data where relevant logical features may be represented at multiple levels of granularity). For example, input data represented as a three-dimensional scene may have relevant hierarchical levels including the entire scene itself (e.g., evaluating multiple three-dimensional objects in the scene), each individual object (e.g., evaluating each object independently), each individual face of each object (e.g., evaluating each face independently), each individual vertex of each face (e.g., evaluating each vertex independently), and the like. As another example, a model may receive input consisting of multiple modalities where each modality has a respective hierarchy. For example, an image input may have an image-wide level (evaluating all pixels in the image), a patch-wide level (evaluating each patch individually), and the like. As yet another example, if the input is a video (e.g., a sequence of images), the broadest level may correspond to the entire sequence, the next level may correspond to each image in the sequence, and the next level may correspond to patches within each image.

However, many conventional architectures and techniques are not designed to effectively process such hierarchical structures. For example, transformers, which are often used in a wide variety of machine learning models, can process a sequence of tokens but generally have limited (or no) visibility or understanding of the broader hierarchical structures reflected inherently in the data. In some aspects of the present disclosure, architectures and techniques for hierarchical attention (e.g., hierarchical transformer architectures) are provided. Using some aspects of the present disclosure, the hierarchical structure of the data is evaluated by the model, resulting in improved model performance (e.g., increased accuracy) in some aspects. Further, the disclosed techniques retain advantages provided by conventional transformer architectures, including computational efficiency, expressivity, and scalability.

In some aspects of the present disclosure, a transformer architecture is modified by retaining some components of the transformer (e.g., nonlinearities, linear layers, normalization layers, and the like) unchanged and replacing the attention component with a hierarchical attention mechanism. In some aspects, the hierarchical attention is performed using attention masking at each level of the hierarchy. For example, for input data corresponding to a three-dimensional environment, a first attention mask may correspond to full attention over the entirety of the tokens (e.g., all tokens) in the scene, a second attention mask may correspond to limiting attention to tokens that are part of the same object, a third attention mask may correspond to limiting attention to tokens that are part of the same mesh face, and the like.

In some aspects, for each level of the hierarchy, a set of multiple attention heads is used. For example, the system may use N*k attention heads, where N is the number of levels in the hierarchy and k is a hyperparameter (e.g., with a value of eight, sixteen, thirty-two, sixty-four, and the like). That is, each of the N attention masks (e.g., each level in the hierarchy) may be used by k attention heads. In some aspects, the output of each head may be aggregated (e.g., via concatenation) to be provided as input to subsequent components, as discussed in more detail below.

Advantageously, the hierarchical attention mechanisms discussed herein can effectively process the hierarchical structure of the data to enable better model performance in a computationally efficient, scalable, and expressive manner. Further, the disclosed attention mechanisms are readily compatible with a wide variety of other transformer variations, and can be used to perform a multiplicity of tasks in any number of environments (e.g., predicting object motion in robotics, autonomous driving, and the like).

### Example Workflow for Hierarchical Machine Learning Models

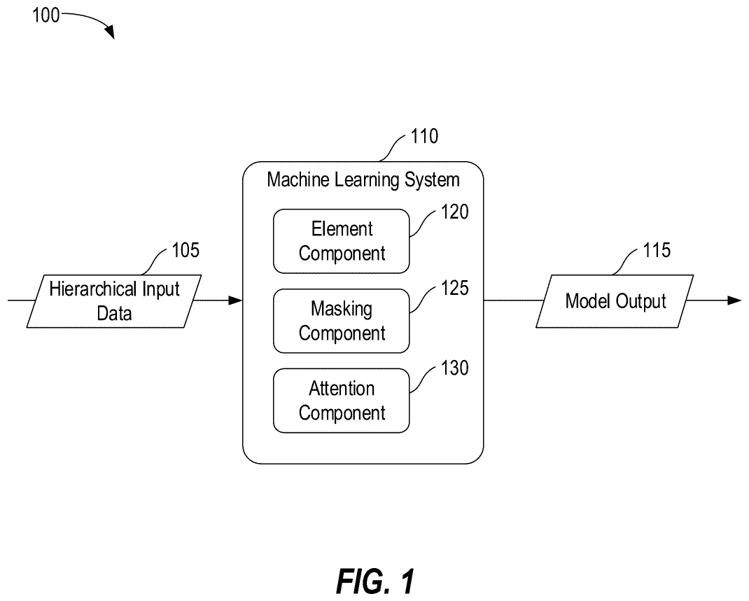

FIG. 1 depicts an example workflow 100 for hierarchical machine learning models, according to some aspects of the present disclosure.

In the depicted workflow 100, a machine learning system 110 accesses hierarchical input data 105 to generate a model output 115. As used herein, “accessing” data may generally include receiving, requesting, retrieving, obtaining, generating, collecting, to otherwise gaining access to the data. Although depicted as a discrete computing system for conceptual clarity, in some aspects, the operations of the machine learning system 110 may be implemented using hardware, software, or a combination of hardware and software, and may be distributed across any number and variety of systems.

In some aspects, the hierarchical input data 105 generally comprises a set of elements (referred to as “tokens” in some aspects) with an associated hierarchical structure. The particular contents and format of the hierarchical input data 105 may vary depending on the particular implementation and task. For example, if the machine learning system 110 performs a computer vision task, the hierarchical input data 105 may comprise image data (e.g., a set of one or more images, each image having one or more patches and/or one or more pixels). As another example, if the machine learning system 110 is tasked with processing three-dimensional scene data, the hierarchical input data 105 may comprise a set of three-dimensional objects, each having a set of faces, where each face comprises a set of vertices.

In some aspects, the particular content and format of the model output 115 may similarly vary depending on the particular implementation and task. For example, the model output 115 may include predictions relating to the movement of objects reflected or depicted in the hierarchical input data 105.

In some aspects, the machine learning system 110 may comprise or implement one or more machine learning models. In some aspects, as part of the machine learning model operations, the machine learning system 110 may perform one or more attention operations (e.g., using transformers) to process the hierarchical input data 105. Attention operations (such as self-attention operations) generally use learned weight tensors to project input features (e.g., the elements of the hierarchical input data 105 or features generated therefrom) to a set of intermediate data (e.g., query (Q), key (K), and value (V) matrices). These intermediate data tensors can then be combined or evaluated to generate an attention score for each respective token (e.g., for each element of the hierarchical input data 105) based on the data contained in the respective token as well as the data contained in one or more other tokens in the hierarchical input data 105. For example, the attention score of a given token may be generated based on the key matrix of the given token and the query matrix of the one or more other tokens.

In some aspects, this attention score acts as the weight by which the value matrix of the token is weighted. This weighted value matrix may be referred to in some aspects as the attention output of the token (e.g., the output of the attention operation for the token).

In some aspects, in addition to or instead of causing each token in the hierarchical input data 105 (or features generated therefrom) to attend to each other token using the attention mechanism, the machine learning system 110 may further generate hierarchical attention. In some aspects, the machine learning system 110 may generate attention output(s) at multiple levels of the hierarchy, where the hierarchy defines partitions of tokens that are used for each respective attention operation. That is, in some aspects, the machine learning system 110 may generate a respective attention output for each respective element reflected in the hierarchical input data 105, where an element may be at any level of the hierarchy and may correspond to a partition of tokens from the hierarchical input data 105.

For example, if the hierarchical input data 105 corresponds to a three-dimensional scene, a first level may correspond to the entire scene (e.g., a single element in the first level, where the single element comprises all tokens in the data). A second level of the hierarchy may be the object level, where each element in the second level corresponds to a respective object in the scene (e.g., where each element in the second level comprises a partition of the tokens, from the hierarchical input data 105, that are part of the same corresponding object). Further, a third level may correspond to the face-level, where each element at this third level corresponds to a face of an object in the scene (e.g., comprising a partition of tokens associated with the corresponding face), and so on. Generally, the hierarchical input data 105 may include any number of tokens and any number of logical elements distributed across any number of levels of the hierarchy.

In some aspects, by computing attention output with respect to each element at each level of the hierarchy (e.g., using multi-headed attention), the machine learning system 110 is able to capture the hierarchical structure of the input and generate improved (e.g., more accurate) output predictions in some aspects.

In the illustrated example, the machine learning system 110 includes an element component 120, a masking component 125, and an attention component 130. Although not included in the illustrated example, in some aspects, the machine learning system 110 may include other components, such as to train machine learning models (e.g., to learn the values for the matrices used to generate the queries, keys, and values, among other parameters). Although depicted as discrete components for conceptual clarity, in some aspects, the operations of the depicted components (and others not illustrated) may be combined or distributed across any number of components. For example, the masking component 125 may be implemented as part of the operations of the attention component 130.

In the illustrated workflow 100, the element component 120 may be used to define or identify the level of the hierarchical input data 105, the individual elements in the hierarchical input data 105, and/or the relevant partition of tokens with respect to each such element. For example, the hierarchical input data 105 may include metadata or other information indicating the structure (e.g., indicating element(s) to which each token corresponds). In some aspects, the element component 120 may evaluate the hierarchical input data 105 to determine or infer the hierarchy and/or elements directly. For example, if the hierarchical input data 105 comprises a set of points (e.g., generated using light detection and ranging (LIDAR) sensors), the element component 120 may infer or identify the distinct objects in the scene (e.g., which points correspond to which objects). In some aspects, the element component 120 may generally determine the partition of tokens that corresponds to each element in the hierarchical input data 105, allowing attention to be computed with respect to each of these elements.

In the depicted example, the masking component 125 may be used to mask the attention operations based on the elements determined by the element component 120. In some aspects, the masking component 125 may mask the attention operations such that a respective attention output is generated for each respective element based on the corresponding partition of tokens for the respective element. That is, the masking component 125 may mask the hierarchical input data 105 to allow attention to be performed separately with respect to each element at each level of the hierarchy. For example, in the case of a three-dimensional scene, the masking component 125 may enable generation of attention output for a first mesh face based on the vertices that form the face (e.g., by masking out vertices corresponding to other faces), as well as generation of attention output for a first object based on the vertices that form the object (e.g., by masking out vertices corresponding to other objects), and so on.

The attention component 130 may generally be used to perform the attention operations of the machine learning model (e.g., based on the masks generated by the masking component 125). For example, the attention component 130 may use learned parameters to generate the intermediate attention data (e.g., the keys, queries, and values for each token), and may then generate attention output for each element in the hierarchy based on the attention masks. In some aspects, the attention output for each element at a given level of the hierarchy can be aggregated (e.g., concatenated) to generate an attention output for the level. In some aspects, the attention output for each level of the hierarchy can similarly be aggregated (e.g., using concatenation, summation, and the like) to generate an overall attention output of the attention component 130.

Although not depicted in the illustrated example, in some aspects, the machine learning system 110 may perform any number of attention operations, as well as any other machine learning operations (e.g., using feedforward layers, linear layers, nonlinear layers, normalization layers, and the like) to generate the model output 115 based on the hierarchical input data 105. As discussed above, by using hierarchical attention to process the hierarchical input data 105, the machine learning system 110 can generate improved (e.g., more accurate) output predictions, as compared to some conventional models relying on conventional attention.

### Example Hierarchical Data in Machine Learning Models

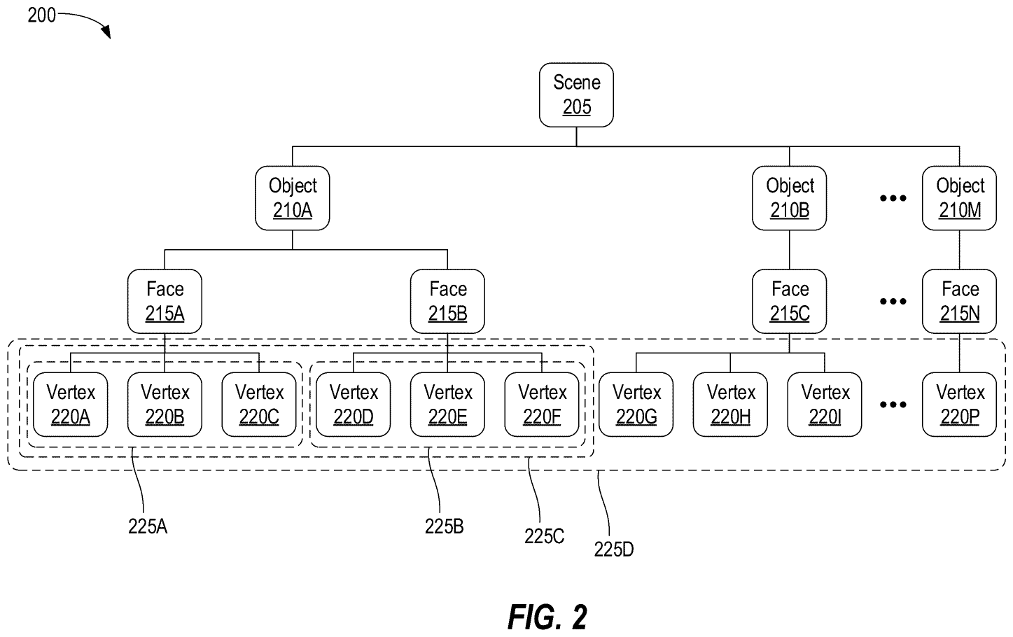

FIG. 2 depicts example hierarchical data 200 in machine learning models, according to some aspects of the present disclosure. In some aspects, the hierarchical data 200 corresponds to the hierarchical input data 105 of FIG. 1. In some aspects, the hierarchical data 200 is processed by a machine learning system, such as the machine learning system 110 of FIG. 1.

In the illustrated example, the hierarchical data 200 corresponds to a three-dimensional scene (e.g., a virtual scene including one or more modeled objects). Although the illustrated example depicts three-dimensional input data, as discussed above, the particular contents and structure of the hierarchical data 200 may vary depending on the particular implementation.

In the illustrated example, the hierarchical data 200 is delineated into a set of levels (e.g., three or four levels, depending on whether the vertex level is a separate level). Specifically, as illustrated, a set of vertices 220A-P (collectively, vertices 220) corresponds to the individual tokens of the hierarchical data 200. The individual vertices may comprise data based on which the attention is generated, such as the position of each vertex 220 and any other relevant information (e.g., the type or category of each vertex, the color of each vertex, and the like, depending on the particular implementation).

As illustrated, the vertices 220 form faces 215A-N (collectively, faces 215) in the scene. That is, one level of the hierarchy may correspond to the face level, where each face 215 comprises and/or is defined by a set of vertices 220. For example, in the depicted hierarchical data 200, the face 215A comprises the vertices 220A, 220B, and 220C. The face 215B comprises the vertices 220D, 220E, and 220F. The face 215C comprises the vertices 220G, 220H, and 220I. The face 215N comprises the vertex 220P.

Further, as illustrated, the faces 215 form objects 210A-M in the scene. That is, another level of the hierarchy may correspond to the object level, where each object comprises and/or is defined by one or more faces 215 (thereby comprising one or more vertices 220). For example, in the depicted hierarchical data 200, the object 210A includes the faces 215A and 215B. The object 210A therefore includes the vertices 220A, 220B, 220C, 220D, 220E, and 220F. Similarly, the object 210B includes at least the face 215C, thereby including the vertices 220G, 220H, and 220I. Further, the object 210M includes the face 215N, corresponding to the vertex 220P.

Additionally, in the illustrated example, the objects 210 are part of a scene 205. That is, another level of the hierarchy may correspond to the scene level, where the scene 205 corresponds to or comprises all of the elements in the data. In some aspects, as discussed above, each logical partition at each level of the hierarchical data 200 may be referred to as an “element.” For example, each vertex 220 may be its own “element” at the vertex level, each face 215 may be an “element” at the face level, each object 210 may be an “element” at the object level, and the scene 205 may be an “element” at the scene level. Generally, the hierarchical data 200 may include any number of elements at any number of levels of the hierarchy, where each element at a given level may include any number of elements at the level below the given level (e.g., the scene 205 may include any number of objects 210, each object 210 may include any number of faces 215, each face may include any number of vertices 220, and each vertex 220 may include any relevant data (including elements of another lower level, in some aspects).

As discussed above, in some aspects, the machine learning system (e.g., the machine learning system 110 of FIG. 1) may perform attention operations independently for each element at each level of the hierarchical data 200. In some aspects, as discussed above, the attention output for a given element is generated based on a corresponding partition of tokens (e.g., vertices 220) that belong to or are otherwise associated with or included in the given element.

For example, in the illustrated data, the partition 225A (including the vertices 220A, 220B, and 220C) corresponds to the face 215A. That is, when computing attention for the face 215A, the machine learning system may evaluate the vertices 220A, 220B, and 220C from the partition 225A. As illustrated, this attention operation for the face 215A excludes tokens that are not in the partition 225A. That is, the attention output of the face 215A is not generated based on the vertices 220D, 220E, 220F, 220G, 220H, 220I, 220P, and so on.

As another example, in the illustrated data, the partition 225B (including the vertices 220D, 220E, and 220F) corresponds to the face 215B. That is, when computing attention for the face 215B, the machine learning system may evaluate the vertices 220D, 220E, and 220F from the partition 225B. As illustrated and discussed above, this attention operation for the face 215B excludes tokens that are not in the partition 225B (e.g., the vertices 220A, 220B, 220C, 220G, 220H, 220I, 220P, and so on).

Further, in the illustrated data, the partition 225C (including the vertices 220A, 220B, 220C, 220D, 220E, and 220F) corresponds to the object 210A. That is, when computing attention for the object 210A, the machine learning system may evaluate the vertices 220A, 220B, 220C, 220D, 220E, and 220F from the partition 225C. As illustrated and discussed above, this attention operation for the object 210A excludes tokens that are not in the partition 225C (e.g., the vertices 220G, 220H, 220I, 220P, and so on).

Additionally, in the illustrated data, the partition 225D (which includes all of the vertices 220) corresponds to the scene 205. That is, when computing attention for the scene 205, the machine learning system may evaluate all of the vertices 220 in the hierarchical data 200.

Additionally, though not explicitly depicted as partitions in the illustrated example, the attention output for the face 215C may be generated based on the vertices 220G, 220H, and 220I (excluding other vertices such as the vertices 220A, 220B, 220C, 220D, 220E, 220F, and 220P), the attention output for the object 210B may be generated based on the vertices 220G, 220H, and 220I, the attention output for the face 215N may be generated based on the vertex 220P, and so on.

In this way, as discussed above, the machine learning system can generate attention output for each element at each level of the hierarchical data 200. That is, while some conventional approaches generate attention globally (e.g., based on all of the vertices 220, or based on a sliding window of vertices), the machine learning system can generate attention in a granular manner based on the structure of the data itself, resulting in significantly improved model accuracy in some aspects.

### Example Workflow for Hierarchical Attention in Machine Learning Models

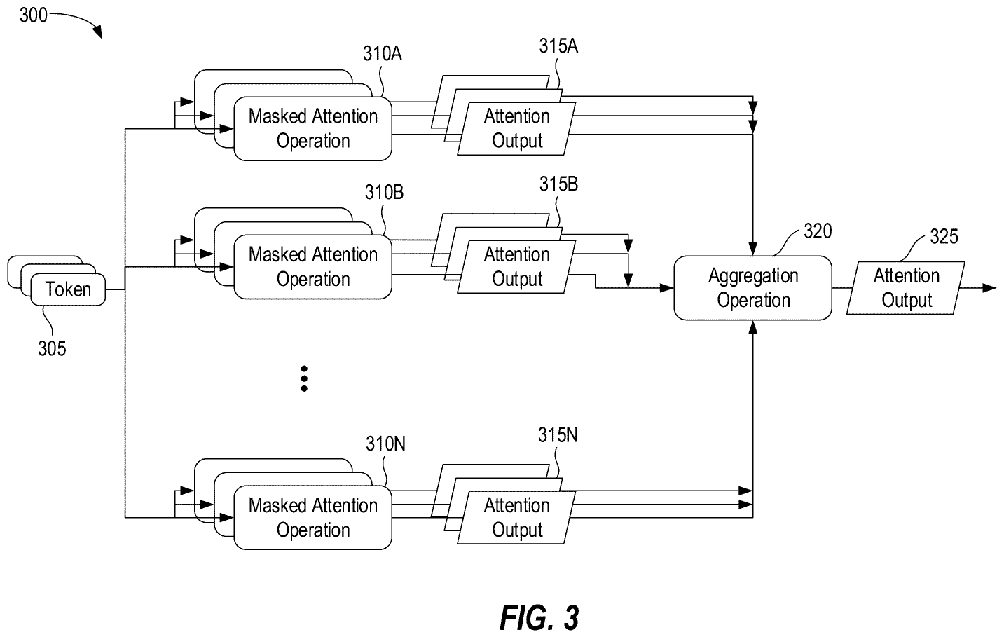

FIG. 3 depicts an example workflow 300 for hierarchical attention in machine learning models, according to some aspects of the present disclosure. In some aspects, the workflow 300 is performed by a machine learning system, such as the machine learning system 110 of FIG. 1 and/or the machine learning system discussed above with reference to FIG. 2. In some aspects, the workflow 300 is performed by an attention component, such as the attention component 130 of FIG. 1.

In the illustrated workflow 300, a set of tokens 305 is processed to generate attention output 325 (referred to in some aspects as “aggregated attention output”). In some aspects, as discussed above, the tokens 305 may be components of a hierarchical data structure, such as the hierarchical input data 105 of FIG. 1 and/or the hierarchical data 200 of FIG. 2. For example, the tokens 305 may correspond to the vertices 220 of FIG. 2. In some aspects, the tokens 305 represent the lowest level of the hierarchy. That is, each element in the input data may comprise or correspond to one or more tokens 305.

In the illustrated example, the tokens 305 are processed by a set of masked attention operations 310A-N (collectively, masked attention operations 310). In some aspects, as discussed above, the tokens 305 may be processed at multiple levels of the hierarchy (e.g., for N levels). In some aspects, each of the N levels may have a corresponding k attention heads, where k is a hyperparameter. Specifically, in the illustrated example, the set of masked attention operations 310A may correspond to a first level of the hierarchy (e.g., the scene level), the set of masked attention operations 310B may correspond to a second level of the hierarchy (e.g., the object level), and the set of masked attention operations 310N may correspond to a third level of the hierarchy (e.g., the mesh face level). Although three levels are depicted in the illustrated example, in some aspects, the machine learning system may use any number of levels in the hierarchy. Further, although the illustrated example depicts three masked attention operations 310 (e.g., three attention heads) at each level of the hierarchy, each level may generally include any number of attention heads.

As discussed above, in some aspects, each level of the attention mechanism may mask the attention operation using a corresponding attention mask (or masks) to limit the influence of the tokens 305 (where each attention mask may be used by k heads at the corresponding level). For example, at the level corresponding to the masked attention operations 310N, an attention mask may be used to limit attention to elements within the same mesh face. That is, the masked attention operations 310N may generate, for each respective element at this level (e.g., each mesh face) a respective set of attention output(s) 315N based on the respective partition of the tokens 305 that corresponds to the respective element. In the illustrated example, if k attention heads are used, the machine learning system may generate k attention outputs 315N for each element at this level.

As discussed above, in some aspects, the attention outputs 315 correspond to the weighted value tensor(s) of the corresponding partition of token(s) 305. For example, each masked attention operation 310 may compute a key tensor, a query tensor, and a value tensor for each token 305 in the corresponding partition. Attention score(s) can then be generated based on the keys and queries of the token(s) 305 in the partition, and these attention score(s) can be used to weight the value tensor(s) to generate the attention output(s) 315.

Further, at the level corresponding to the masked attention operations 310B, an attention mask may be used to limit attention to elements within the same object. That is, the masked attention operations 310B may generate, for each respective element at this level (e.g., each object) a respective set of attention output(s) 315B based on the respective partition of the tokens 305 that corresponds to the respective element. As discussed above, in the illustrated example, if k attention heads are used, the machine learning system may generate k attention outputs 315B for each element at this level.

Additionally, at the level corresponding to the masked attention operations 310A, an attention mask may be used to limit attention to elements within the same scene (e.g., if multiple scenes are included in the input data). In some aspects, the attention at the highest level of the hierarchy may be performed without any masking. That is, the attention output(s) 315 at the highest level of the hierarchy may be performed based on all of the tokens 305 in the input.

In the illustrated example, the attention outputs 315A, 315B, and 315N from each level of the attention mechanism are accessed by an aggregation operation 320, which generates attention output 325 for the tokens 305. Generally, the aggregation operation 320 may use a variety of operations to aggregate the attention outputs 315. For example, in some aspects, the attention outputs 315 from a given level of the hierarchy may be concatenated. That is, the attention output(s) 315A of each element from the first level may be concatenated to form an attention output at this level of the data, the attention output(s) 315B of each element from the second level may be concatenated to form an attention output at this second level, and the attention output(s) 315N of each element of the third level may be concatenated to form an attention output at this third level.

In some aspects, the attention output(s) from each level may further be aggregated by the aggregation operation 320. For example, the aggregation operation 320 may further concatenate the attention outputs 315 to form a single attention output 325 for the tokens 305, or may perform other aggregation operations such as summing, averaging, and the like.

Although not included in the illustrated example, the attention output 325 may then be processed using one or more downstream components of the machine learning model. For example, the attention output 325 may be processed using one or more linear layers, nonlinear layers, activation functions, normalization layers, and the like. Similarly, although not included in the illustrated example, in some aspects, the concatenated attention outputs 315 from each level may undergo further processing prior to being aggregated by the aggregation operation 320. For example, the attention outputs 315A may be aggregated and processed (e.g., using a linear layer), and the resulting output may then be aggregated with the data output from each other level of the hierarchy.

As discussed above, this hierarchical attention mechanism therefore enables improved attention to be generated with awareness of the structure of the tokens 305, which can result in substantially improved model performance and accuracy.

### Example Method for Hierarchical Attention in Machine Learning Models

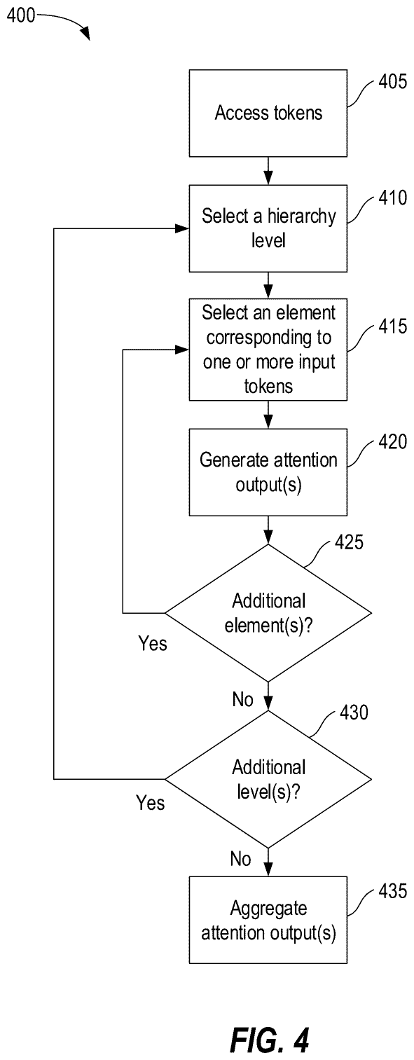

FIG. 4 is a flow diagram depicting an example method 400 for hierarchical attention in machine learning models, according to some aspects of the present disclosure. In some aspects, the method 400 is performed by a machine learning system, such as the machine learning system 110 of FIG. 1, and/or the machine learning systems discussed above with reference to FIGS. 2-3.

At block 405, the machine learning system accesses a set of tokens as input to an attention mechanism of a machine learning model. For example, as discussed above, the tokens may correspond to the tokens 305 of FIG. 3, the vertices 220 of FIG. 2, and/or the hierarchical input data 105 of FIG. 1. Generally, the tokens may be associated with a hierarchical structure having any number of levels, as discussed above.

At block 410, the machine learning system selects a level of the hierarchical structure. Generally, the machine learning system may select the level using any suitable technique, including randomly or pseudo-randomly, as each level of the hierarchy may be processed during execution of the method 400. As discussed above, the levels of the hierarchy generally correspond to the logical elements of the input data (e.g., a scene level including all tokens, an object level indicating the discrete objects in the scene, a face level indicating the discrete faces of each object, and/or a vertex level indicating the discrete vertices of each face).

At block 415, the machine learning system selects an element from the selected level of the hierarchy, where the element corresponds to or comprises a set of one or more tokens. Generally, the machine learning system may select the element using any suitable technique, including randomly or pseudo-randomly, as each element of the selected level may be processed during execution of the method 400. In some aspects, as discussed above, the set of token(s) that corresponds to the selected element may be referred to as a partition of the input tokens. For example, for a scene element, the corresponding partition of tokens may comprise all of the tokens in the input. For an object element, the corresponding partition of tokens may comprise the tokens that define the face(s) that are part of the object. For a face element, the corresponding partition of tokens may comprise the tokens that define the face.

At block 420, the machine learning system generates one or more attention output(s) for the selected element based on the corresponding partition of tokens. In some aspects, as discussed above, the machine learning system may use a set of attention heads (e.g., k heads) to generate multi-headed attention output for the element. In some aspects, as discussed above, the attention output(s) are generated using masked attention operation(s) (e.g., the masked attention operation(s) 310 of FIG. 3) to mask the attention such that the attention outputs for a given element are generated based on the token(s) corresponding to the element, where one or more other token(s) are not included or evaluated with respect to the selected element.

At block 425, the machine learning system determines whether there is at least one additional element at the selected level of the input data that has not yet been processed to generate attention output. If so, the method 400 returns to block 415. If not, the method 400 continues to block 430. Although the illustrated example depicts an iterative process (e.g., processing each element sequentially) for conceptual clarity, in some aspects, the machine learning system may process some or all of the elements entirely or partially in parallel.

At block 430, the machine learning system determines whether there is at least one additional level in the hierarchical data that has not yet been processed to generate attention output(s). If so, the method 400 returns to block 410. If not, the method 400 continues to block 435. Although the illustrated example depicts an iterative process (e.g., processing each level sequentially) for conceptual clarity, in some aspects, the machine learning system may process some or all of the levels entirely or partially in parallel.

At block 435, the machine learning system aggregates the attention outputs (from each element at each level) to generate an overall attention output for the tokens, as discussed above. For example, the machine learning system may concatenate the attention outputs, sum or average the attention outputs, and the like. Although not depicted in the illustrated example, in some aspects, as discussed above, the machine learning system may aggregate the attention outputs within each level (e.g., concatenating the attention outputs of each element to form an attention output of the element, and/or concatenating the outputs of each element within a level to generate an attention output for the level) before aggregating the attention outputs across levels.

In some aspects, by performing hierarchical attention with respect to each element at each level of the hierarchical input data, the machine learning system may enable improved attention to be generated with awareness of the structure of the tokens, which can result in substantially improved model performance and accuracy.

### Example Method for Hierarchical Machine Learning

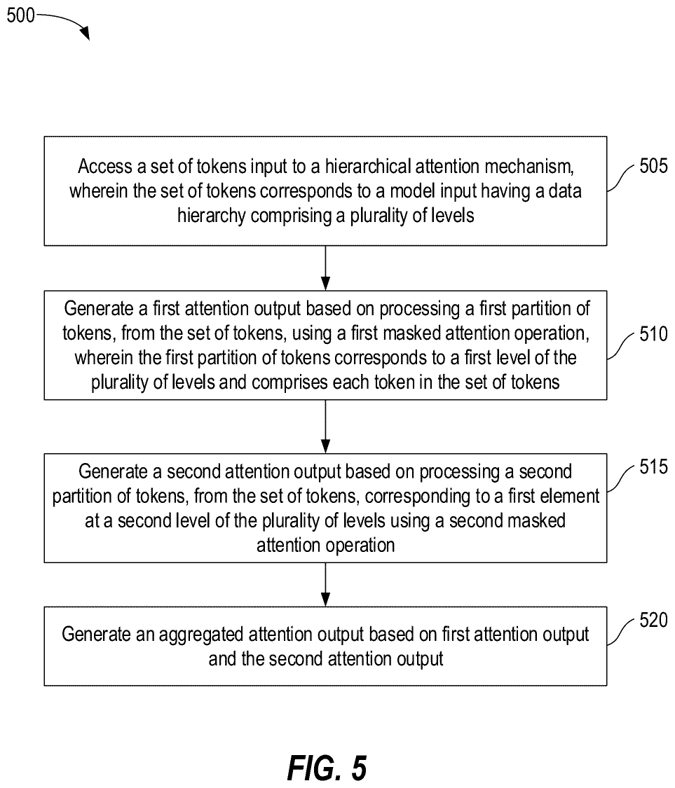

FIG. 5 is a flow diagram depicting an example method 500 for hierarchical machine learning, according to some aspects of the present disclosure. In some aspects, the method 500 is performed by a machine learning system, such as the machine learning system 110 of FIG. 1, and/or the machine learning systems discussed above with reference to FIGS. 2-4.

At block 505, a set of tokens (e.g., the hierarchical input data 105 of FIG. 1, the hierarchical data 200 of FIG. 2, and/or the tokens 305 of FIG. 3) input to a hierarchical attention mechanism (e.g., the attention component 130 of FIG. 1 and/or the masked attention operations 310A-N of FIG. 3) is accessed. The set of tokens may correspond to a model input having a data hierarchy comprising a plurality of levels.

At block 510, a first attention output (e.g., the attention output 315A of FIG. 3) is generated based on processing a first partition of tokens, from the set of tokens, using a first masked attention operation. The first partition of tokens corresponds to a first level of the plurality of levels and comprises each token in the set of tokens.

At block 515, a second attention output (e.g., the attention output 315B of FIG. 3) is generated based on processing a second partition of tokens, from the set of tokens, corresponding to a first element at a second level of the plurality of levels using a second masked attention operation.

At block 520, an aggregated attention output (e.g., the attention output 325 of FIG. 3) is generated based on the first attention output and the second attention output.

In some aspects, the second masked attention operation excludes a third partition of tokens, from the set of tokens, corresponding to a second element at the second level.

In some aspects, the method 500 further includes generating a third attention output (e.g., the attention output 315N of FIG. 3) based on processing a third partition of tokens, from the set of tokens, corresponding to a second element at the second level using a third masked attention operation. The aggregated attention output may be generated based further on the third attention output.

In some aspects, the method 500 further includes generating a fourth attention output based on processing a fourth partition of tokens, from the set of tokens, corresponding to a third element at a third level of the plurality of levels using a fourth masked attention operation. The fourth partition of tokens may include the second and third partitions of tokens. The aggregated attention output may be generated based further on the fourth attention output.

In some aspects, the method 500 further includes (i) generating, for each respective element at the second level, a respective attention output based on a respective corresponding partition of tokens and (ii) generating, for each respective element at a third level of the plurality of levels, a respective attention output based on a respective corresponding partition of tokens. The aggregated attention may be generated based further on the respective attention scores.

In some aspects, aggregating the first attention output and the second attention output comprises concatenating the first and second attention output.

In some aspects, the first masked attention operation comprises operating a first plurality of attention heads (e.g., the masked attention operations 310A of FIG. 3) and corresponds to an entirety of the set of tokens.

In some aspects, the second masked attention operation comprises operating a second plurality of attention heads (e.g., the masked attention operations 310B of FIG. 3) and corresponds to the second level.

In some aspects, the hierarchical attention mechanism further comprises a third masked attention operation (e.g., the masked attention operation 310N of FIG. 3) comprising operating a third plurality of attention heads and corresponding to a third level of the plurality of levels.

In some aspects, the method 500 further includes generating a machine learning model output (e.g., the model output 115 of FIG. 1) based on the aggregated attention output.

In some aspects, the model input comprises a set of objects in a three-dimensional scene. In such aspects, the first level of the plurality of levels may correspond to an entirety of vertices (e.g., the vertices 220A-P of FIG. 2) in the three-dimensional scene (e.g., the scene 205 of FIG. 2), the second level of the plurality of levels may correspond to partitioning vertices based on the set of objects (e.g., the objects 210A-M of FIG. 2), and a third level of the plurality of levels may correspond to partitioning vertices based on faces of the set of objects (e.g., the faces 215A-N of FIG. 2).

In some aspects, the model input comprises an image. In such aspects, the second level of the plurality of levels corresponds to patches of the image.

In some aspects, the model input comprises a sequence of images, the second level of the plurality of levels corresponds to images in the sequence of images, and a third level of the plurality of levels corresponds to patches of the images.

### Example Processing System for Machine Learning

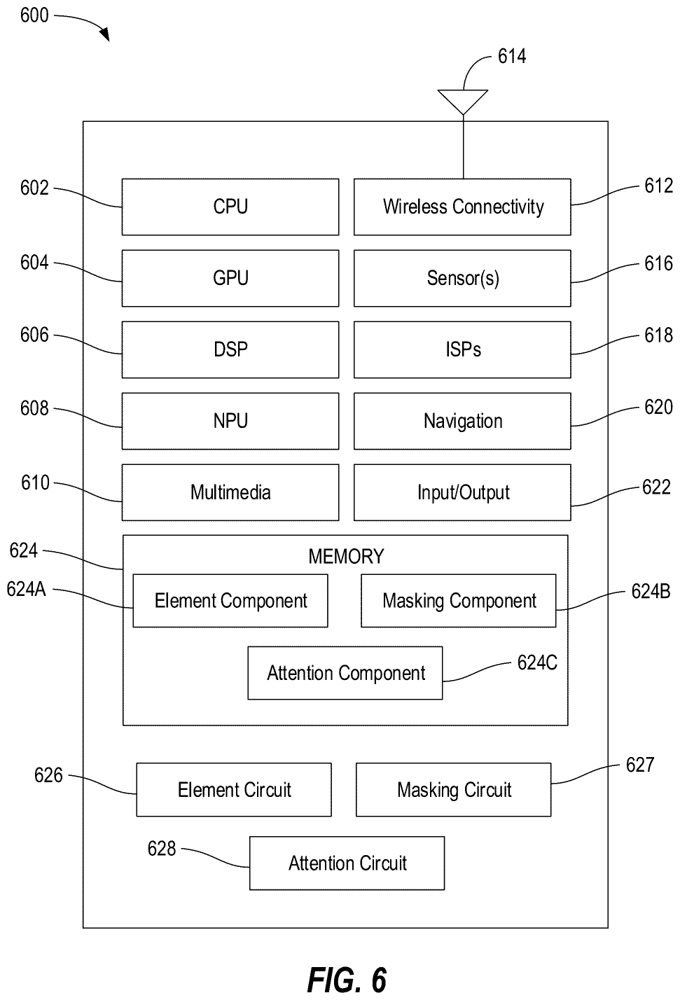

FIG. 6 depicts an example processing system 600 configured to perform various aspects of the present disclosure, including, for example, the techniques and methods described with respect to FIGS. 1-5. In some aspects, the processing system 600 may correspond to a machine learning system. For example, the processing system 600 may correspond to the machine learning system 110 of FIG. 1 and/or the machine learning system discussed above with reference to FIGS. 2-5. Although depicted as a single system for conceptual clarity, in some aspects, as discussed above, the components described below with respect to the processing system 600 may be distributed across any number of devices or systems.

The processing system 600 includes a central processing unit (CPU) 602, which in some examples may be a multi-core CPU. Instructions executed at the CPU 602 may be loaded, for example, from a program memory associated with the CPU 602 or may be loaded from a memory partition (e.g., a partition of a memory 624).

The processing system 600 also includes additional processing components tailored to specific functions, such as a graphics processing unit (GPU) 604, a digital signal processor (DSP) 606, a neural processing unit (NPU) 608, a multimedia component 610 (e.g., a multimedia processing unit), and a wireless connectivity component 612.

An NPU, such as the NPU 608, is generally a specialized circuit configured for implementing the control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as the NPU 608, are configured to accelerate the performance of common machine learning tasks, such as image classification, machine translation, object detection, and various other predictive models. In some examples, a plurality of NPUs may be instantiated on a single chip, such as a system on a chip (SoC), while in other examples the NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this piece of data through an already trained model to generate a model output (e.g., an inference). In some implementations, the NPU 608 is a part of one or more of the CPU 602, the GPU 604, and/or the DSP 606.

In some examples, the wireless connectivity component 612 may include subcomponents, for example, for third generation (3G) connectivity, fourth generation (4G) connectivity (e.g., Long-Term Evolution (LTE)), fifth generation (5G) connectivity (e.g., New Radio (NR)), Wi-Fi connectivity, Bluetooth connectivity, and other wireless data transmission standards. The wireless connectivity component 612 is further coupled to one or more antennas 614.

The processing system 600 may also include one or more sensor processing units 616 associated with any manner of sensor, one or more image signal processors (ISPs) 618 associated with any manner of image sensor, and/or a navigation processor 620, which may include satellite-based positioning system components (e.g., GPS or GLONASS) as well as inertial positioning system components.

The processing system 600 may also include one or more input and/or output devices 622, such as screens, touch-sensitive surfaces (including touch-sensitive displays), physical buttons, speakers, microphones, and the like.

In some examples, one or more of the processors of the processing system 600 may be based on an ARM or RISC-V instruction set.

The processing system 600 also includes a memory 624, which is representative of one or more static and/or dynamic memories, such as a dynamic random access memory, a flash-based static memory, and the like. In this example, the memory 624 includes computer-executable components, which may be executed by one or more of the aforementioned processors of the processing system 600.

In particular, in this example, the memory 624 includes an element component 624A, a masking component 624B, and an attention component 624C. Although not depicted in the illustrated example, the memory 624 may also include other components, such as a training component used to train or update machine learning model(s). Though depicted as discrete components for conceptual clarity in FIG. 6, the illustrated components (and others not depicted) may be collectively or individually implemented in various aspects.

Further, although not depicted in the illustrated example, the memory 624 may also include other data such as model parameters (e.g., parameters of one or more machine learning models), training data for the machine learning model(s), input data (e.g., the hierarchical input data 105 of FIG. 1, the hierarchical data 200 of FIG. 2, and/or the tokens 305 of FIG. 3), and the like.

The processing system 600 further comprises an element circuit 626, a masking circuit 627, and an attention circuit 628. The depicted circuits, and others not depicted (such as an inferencing circuit), may be configured to perform various aspects of the techniques described herein.

The element component 624A and/or the element circuit 626 (which may correspond to the element component 120 of FIG. 1) may be used to define, determine, or otherwise identify the logical elements and/or levels reflected in the input data, as discussed above. For example, the element component 624A and/or the element circuit 626 may determine how the tokens of the input data should be partitioned at each level of the hierarchy based on the element(s) to which the tokens correspond.

The masking component 624B and/or the masking circuit 627 (which may correspond to the masking component 125 of FIG. 1) may be used to generate and/or use attention masks based on the determined elements, as discussed above. For example, the masking component 624B and/or the masking circuit 627 may be used to ensure that attention can be computed with respect to each respective element at a given level based (only) on the token(s) that correspond to the respective element.

The attention component 624C and/or the attention circuit 628 (which may correspond to the attention component 130 of FIG. 1) may be used to generate hierarchical attention outputs for the input tokens, as discussed above. For example, the attention component 624C and/or the attention circuit 628 may generate attention output for each partition of tokens to generate the hierarchical attention at each level of the hierarchy.

Though depicted as separate components and circuits for clarity in FIG. 6, the element circuit 626, the masking circuit 627, and the attention circuit 628 may collectively or individually be implemented in other processing devices of the processing system 600, such as within the CPU 602, the GPU 604, the DSP 606, the NPU 608, and the like.

Generally, the processing system 600 and/or components thereof may be configured to perform the methods described herein.

Notably, in other aspects, components of the processing system 600 may be omitted, such as where the processing system 600 is a server computer or the like. For example, the multimedia component 610, the wireless connectivity component 612, the sensor processing units 616, the ISPs 618, and/or the navigation processor 620 may be omitted in other aspects. Further, components of the processing system 600 may be distributed between multiple devices.

### Example Clauses

Implementation examples are described in the following numbered clauses:

Clause 1: A method, comprising: accessing a set of tokens input to a hierarchical attention mechanism, wherein the set of tokens corresponds to a model input having a data hierarchy comprising a plurality of levels; generating a first attention output based on processing a first partition of tokens, from the set of tokens, using a first masked attention operation, wherein the first partition of tokens corresponds to a first level of the plurality of levels and comprises each token in the set of tokens; generating a second attention output based on processing a second partition of tokens, from the set of tokens, corresponding to a first element at a second level of the plurality of levels using a second masked attention operation; and generating an aggregated attention output based on the first attention output and the second attention output.

Clause 2: A method according to Clause 1, wherein the second masked attention operation excludes a third partition of tokens, from the set of tokens, corresponding to a second element at the second level.

Clause 3: A method according to any of Clauses 1-2, further comprising generating a third attention output based on processing a third partition of tokens, from the set of tokens, corresponding to a second element at the second level using a third masked attention operation, wherein the aggregated attention output is generated based further on the third attention output.

Clause 4: A method according to Clause 3, further comprising generating a fourth attention output based on processing a fourth partition of tokens, from the set of tokens, corresponding to a third element at a third level of the plurality of levels using a fourth masked attention operation, wherein: the fourth partition of tokens comprises the second and third partitions of tokens, and the aggregated attention output is generated based further on the fourth attention output.

Clause 5: A method according to any of Clauses 1-4, further comprising: generating, for each respective element at the second level, a respective attention output based on a respective corresponding partition of tokens; and generating, for each respective element at a third level of the plurality of levels, a respective attention output based on a respective corresponding partition of tokens, wherein the aggregated attention is generated based further on the respective attention scores.

Clause 6: A method according to any of Clauses 1-5, wherein aggregating the first attention output and the second attention output comprises concatenating the first and second attention output.

Clause 7: A method according to any of Clauses 1-6, wherein the first masked attention operation comprises operating a first plurality of attention heads and corresponds to an entirety of the set of tokens.

Clause 8: A method according to Clause 7, wherein the second masked attention operation comprises operating a second plurality of attention heads and corresponds to the second level.

Clause 9: A method according to Clause 8, wherein the hierarchical attention mechanism further comprises a third masked attention operation comprising operating a third plurality of attention heads and corresponding to a third level of the plurality of levels.

Clause 10: A method according to any of Clauses 1-9, further comprising generating a machine learning model output based on the aggregated attention output.

Clause 11: A method according to any of Clauses 1-10, wherein: the model input comprises a set of objects in a three-dimensional scene, the first level of the plurality of levels corresponds to an entirety of vertices in the three-dimensional scene, the second level of the plurality of levels corresponds to partitioning vertices based on the set of objects, and a third level of the plurality of levels corresponds to partitioning vertices based on faces of the set of objects.

Clause 12: A method according to any of Clauses 1-10, wherein: the model input comprises an image, and the second level of the plurality of levels corresponds to patches of the image.

Clause 13: A method according to any of Clauses 1-10, wherein: the model input comprises a sequence of images, the second level of the plurality of levels corresponds to images in the sequence of images, and a third level of the plurality of levels corresponds to patches of the images.

Clause 14: A processing system comprising: a memory comprising processor-executable instructions; and one or more processors coupled to the one or more memories and configured to execute the processor-executable instructions and cause the processing system to perform a method in accordance with any of Clauses 1-13.

Clause 15: A processing system comprising means for performing a method in accordance with any of Clauses 1-13.

Clause 16: A non-transitory computer-readable medium comprising computer-executable instructions that, when executed by one or more processors of a processing system, cause the processing system to perform a method in accordance with any of Clauses 1-13.

Clause 17: A computer program product embodied on a computer-readable storage medium comprising code for performing a method in accordance with any of Clauses 1-13.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processing system for machine learning comprising:
one or more memories comprising processor-executable instructions; and
one or more processors coupled to the one or more memories and configured to execute the processor-executable instructions and cause the processing system to:
access a set of tokens input to a hierarchical attention mechanism, wherein the set of tokens corresponds to a model input having a data hierarchy comprising a plurality of levels;
generate a first attention output based on a first partition of tokens, from the set of tokens, using a first masked attention operation, wherein the first partition of tokens corresponds to a first level of the plurality of levels and comprises each token in the set of tokens;
generate a second attention output based on processing a second partition of tokens, from the set of tokens, corresponding to a first element at a second level of the plurality of levels using a second masked attention operation; and
generate an aggregated attention output based on the first attention output and the second attention output.

2. The processing system of claim 1, wherein the second masked attention operation excludes a third partition of tokens, from the set of tokens, corresponding to a second element at the second level.

3. The processing system of claim 1, wherein the one or more processors are configured to execute the processor-executable instructions and further cause the processing system to generate a third attention output based on processing a third partition of tokens, from the set of tokens, corresponding to a second element at the second level using a third masked attention operation, and wherein the aggregated attention output is generated based further on the third attention output.

4. The processing system of claim 3, wherein the one or more processors are configured to execute the processor-executable instructions and further cause the processing system to generate a fourth attention output based on processing a fourth partition of tokens, from the set of tokens, corresponding to a third element at a third level of the plurality of levels using a fourth masked attention operation, wherein:
the fourth partition of tokens comprises the second and third partitions of tokens, and
the aggregated attention output is generated based further on the fourth attention output.

5. The processing system of claim 1, wherein the one or more processors are configured to execute the processor-executable instructions and further cause the processing system to:
generate, for each respective element at the second level, a respective attention output based on a respective corresponding partition of tokens; and
generate, for each respective element at a third level of the plurality of levels, a respective attention output based on a respective corresponding partition of tokens, wherein the aggregated attention is generated based further on the respective attention scores.

6. The processing system of claim 1, wherein, to aggregate the first attention output and the second attention output, the one or more processors are configured to execute the processor-executable instructions and further cause the processing system to concatenate the first and second attention output.

7. The processing system of claim 1, wherein the first masked attention operation comprises a first plurality of attention heads and corresponds to an entirety of the set of tokens.

8. The processing system of claim 7, wherein the second masked attention operation comprises a second plurality of attention heads and corresponds to the second level.

9. The processing system of claim 8, wherein the hierarchical attention mechanism further comprises a third masked attention operation comprising a third plurality of attention heads and corresponding to a third level of the plurality of levels.

10. The processing system of claim 1, wherein the one or more processors are configured to execute the processor-executable instructions and further cause the processing system to generate a machine learning model output based on the aggregated attention output.

11. The processing system of claim 1, wherein:
the model input comprises a set of objects in a three-dimensional scene,
the first level of the plurality of levels corresponds to an entirety of vertices in the three-dimensional scene,
the second level of the plurality of levels corresponds to partitioning vertices based on the set of objects, and
a third level of the plurality of levels corresponds to partitioning vertices based on faces of the set of objects.

12. The processing system of claim 1, wherein:
the model input comprises an image, and
the second level of the plurality of levels corresponds to patches of the image.

13. The processing system of claim 1, wherein:
the model input comprises a sequence of images,
the second level of the plurality of levels corresponds to images in the sequence of images, and
a third level of the plurality of levels corresponds to patches of the images.

14. A processor-implemented method for machine learning, comprising:
accessing a set of tokens input to a hierarchical attention mechanism, wherein the set of tokens corresponds to a model input having a data hierarchy comprising a plurality of levels;
generating a first attention output based on processing a first partition of tokens, from the set of tokens, using a first masked attention operation, wherein the first partition of tokens corresponds to a first level of the plurality of levels and comprises each token in the set of tokens;
generating a second attention output based on processing a second partition of tokens, from the set of tokens, corresponding to a first element at a second level of the plurality of levels using a second masked attention operation; and
generating an aggregated attention output based on the first attention output and the second attention output.

15. The processor-implemented method of claim 14, further comprising generating a third attention output based on processing a third partition of tokens, from the set of tokens, corresponding to a second element at the second level using a third masked attention operation, wherein the aggregated attention output is generated based further on the third attention output.

16. The processor-implemented method of claim 15, further comprising generating a fourth attention output based on processing a fourth partition of tokens, from the set of tokens, corresponding to a third element at a third level of the plurality of levels using a fourth masked attention operation, wherein:
the third partition of tokens comprises the second and third partitions of tokens, and
the aggregated attention output is generated based further on the fourth attention output.

17. The processor-implemented method of claim 14, further comprising:
generating, for each respective element at the second level, a respective attention output based on a respective corresponding partition of tokens; and
generating, for each respective element at a third level of the plurality of levels, a respective attention output based on a respective corresponding partition of tokens, wherein the aggregated attention is generated based further on the respective attention scores.

18. The processor-implemented method of claim 14, wherein:
the first masked attention operation comprises operating a first plurality of attention heads and corresponds to an entirety of the set of tokens, and
the second masked attention operation comprises operating a second plurality of attention heads and corresponds to the second level.

19. The processor-implemented method of claim 14, wherein:
the model input comprises a set of objects in a three-dimensional scene,
the first level of the plurality of levels corresponds to an entirety of vertices in the three-dimensional scene,
the second level of the plurality of levels corresponds to partitioning vertices based on the set of objects, and
a third level of the plurality of levels corresponds to partitioning vertices based on faces of the set of objects.

20. A processing system, comprising:
means for accessing a set of tokens input to a hierarchical attention mechanism, wherein the set of tokens corresponds to a model input having a data hierarchy comprising a plurality of levels;
means for generating a first attention output based on processing a first partition of tokens, from the set of tokens, using a first masked attention operation, wherein the first partition of tokens corresponds to a first level of the plurality of levels and comprises each token in the set of tokens;
means for generating a second attention output based on processing a second partition of tokens, from the set of tokens, corresponding to a first element at a second level of the plurality of levels using a second masked attention operation; and
means for generating an aggregated attention output based on the first attention output and the second attention output.
